(19) United States
(12) Patent Application Publication
(10) Pub. No.: US 2021/0342707 A1
(43) Pub. Date: Nov. 4, 2021

(54) DATA-DRIVEN TECHNIQUES FOR MODEL ENSEMBLES

(71) Applicant: INTERNATIONAL BUSINESS MACHINES CORPORATION, ARMONK, NY (US)

(72) Inventors: JING XU, XIAN (CN); STEVEN GEORGE BARBEE, AMENIA, NY (US); JI YANG, BEIJING (CN); SI ER HAN, XIAN (CN); XUE YANG ZHANG, XIAN (CN)

(21) Appl. No.: 15/929,428

(22) Filed: May 1, 2020

(51) Int. Cl. G06N 5/04; G06N 20/20

(52) U.S. Cl. CPC G06N 5/04; G06N 20/20

(57) ABSTRACT

Techniques to ensemble machine learning (ML) models are provided. A plurality of residues is generated by processing a plurality of input records using a plurality of ML models. A plurality of data clusters is identified by evaluating, using a clustering model, the plurality of input records and the plurality of residues. A first ensemble is generated for a first data cluster of the plurality of data clusters, where the first ensemble comprises one or more of the plurality of ML models. Upon determining that a new input record corresponds to the first data cluster, the new input record is processed using the first ensemble.

### BACKGROUND

The present disclosure relates to machine learning, and more specifically, to data-driven techniques to improve model ensembles.

Creating ensembles of machine learning (ML) models has been demonstrated as an effective technique to improve prediction accuracy, as compared to using individual models. Traditionally, ensemble techniques typically focus on finding optimal weights for a linear combination of models, and/or using a meta-learner to combine models in a non-linear way, such as by stacking them. Notably, existing ensemble techniques deal with the data as a whole, neglecting the fact that individual models often have different performance with respect to different data cases. Existing ensemble techniques fail to account for data heterogeneity and yield sub-optimal combinations.

### SUMMARY

According to one embodiment of the present disclosure, a method is provided. The method includes generating a plurality of residues by processing a plurality of input records using a plurality of machine learning (ML) models; identifying a plurality of data clusters by evaluating, using a clustering model, the plurality of input records and the plurality of residues; generating a first ensemble for a first data cluster of the plurality of data clusters, wherein the first ensemble comprises one or more of the plurality of ML models; and upon determining that a new input record corresponds to the first data cluster, processing the new input record using the first ensemble.

According to another embodiment of the present disclosure, a computer program product is provided. The computer program product comprises one or more computer-readable storage media collectively containing computer-readable program code that, when executed by operation of one or more computer processors, performs an operation. The operation includes generating a plurality of residues by processing a plurality of input records using a plurality of machine learning (ML) models; identifying a plurality of data clusters by evaluating, using a clustering model, the plurality of input records and the plurality of residues; generating a first ensemble for a first data cluster of the plurality of data clusters, wherein the first ensemble comprises one or more of the plurality of ML models; and upon determining that a new input record corresponds to the first data cluster, processing the new input record using the first ensemble.

According to still another embodiment of the present disclosure, a system is provided. The system includes one or more computer processors, and one or more memories collectively containing one or more programs which, when executed by the one or more computer processors, performs an operation. The operation includes generating a plurality of residues by processing a plurality of input records using a plurality of machine learning (ML) models; identifying a plurality of data clusters by evaluating, using a clustering model, the plurality of input records and the plurality of residues; generating a first ensemble for a first data cluster of the plurality of data clusters, wherein the first ensemble comprises one or more of the plurality of ML models; and upon determining that a new input record corresponds to the first data cluster, processing the new input record using the first ensemble.

### BRIEF DESCRIPTION OF THE DRAWINGS

FIG. 1 depicts a workflow for data analysis and clustering to improve model ensembles, according to one embodiment disclosed herein.

FIG. 2 is a flow diagram illustrating a method for data analysis and clustering to drive improved model ensembles, according to one embodiment disclosed herein.

FIG. 3 is a flow diagram illustrating a method for generating model ensembles, according to one embodiment disclosed herein.

FIG. 4 is a flow diagram illustrating a method for identifying important and/or indicative fields for data classification, according to one embodiment disclosed herein.

FIG. 5 depicts a workflow for processing input data using model ensembles, according to one embodiment disclosed herein.

FIG. 6 is a flow diagram illustrating a method to ensemble models, according to one embodiment disclosed herein.

FIG. 7 is a block diagram illustrating an environment including a machine learning system configured to perform data-driven analysis to ensemble models, according to one embodiment disclosed herein.

### DETAILED DESCRIPTION

Embodiments of the present disclosure provide techniques to perform data-driven analysis to ensemble models, resulting in improved combinations that reflect the heterogeneity of the data. In one embodiment, supervised techniques of identifying data bumps or clusters are utilized, along with fine-grained strategies to combine individual models, to yield improved ensembles. In addition to improving prediction accuracy, some embodiments of the present disclosure allow for improved techniques to derive data insights and interpret model behaviors.

In many implementations, individual models can perform with various degrees of accuracy based in part on the underlying heterogeneity of the data. For example, suppose there is an anomalous section of the dataset where none of the top otherwise best-performing models do well. Often, some of the lower-performing ML models can nevertheless perform well on these anomalous cases, even while they do not perform well overall. Embodiments of the present disclosure provide improved techniques to ensemble these models, and drive decisions to as to which cases are evaluated by which models, based in part on their prediction performance.

As another example, consider typical multi-classification problems, particularly if one or more minority classes exist. In such scenarios, some models may only perform well for the prediction of particular classes, but not well overall. In such an embodiment, it may be worth generating a distinct ensemble of such models for these special cases. Further, some embodiments of the present disclosure apply to the concept of auto machine learning, where a multitude of models may be available for selection. As each model may perform differently on different data cases, embodiments of the present disclosure provide fine-grained ensemble strategies so that data cases are evaluated by the most powerful models for the individual case.

In some embodiments of the present disclosure, techniques are provided to identify and delineate unique data cases upfront. In at least one embodiment, these collections of cases correspond to multi-dimensional regions of data which are referred to herein to as “data bumps” and/or “data clusters.” In one embodiment, given the predictions from individual models, the system can identify clusters/bumps in a supervised way. In some embodiments, to do so, each prediction can be considered as a projection of the data case (where the model is the projector/transformer). Thus, the predictions can often contain useful information used to pinpoint the bumps of interest.

In an embodiment, the system can first apply a clustering model on an aggregated dataset including the original data fields, as well as the individual prediction residues from each individual model. For each identified cluster or bump, the system can then apply a heuristic strategy for the selection of models, with the objective to achieve the best prediction accuracy for the ensemble model. Additionally, in some embodiments, each data cluster can be profiled based on the prediction accuracies of the original ensemble model and the designed ensemble(s). Further, data bumps can also be profiled by particular data fields if they present significant differences from the overall distributions. Thus, embodiments of the present disclosure generate better models that yield improved predictions. Moreover, embodiments of the present disclosure provide a better way to derive insights about data cases and individual models.

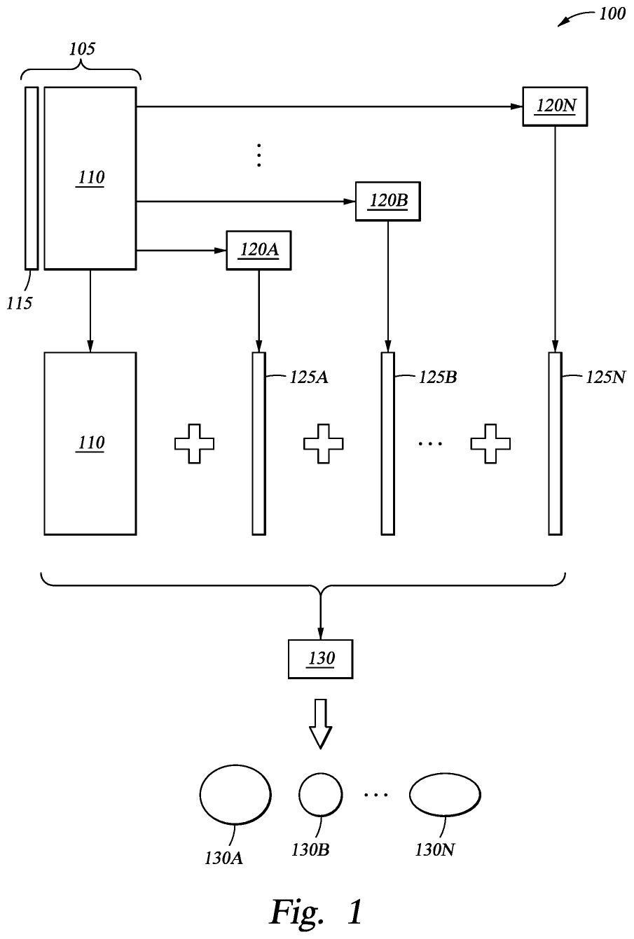

FIG. 1 depicts a workflow 100 for data analysis and clustering to improve model ensembles, according to one embodiment disclosed herein. In one embodiment, the workflow 100 (referred to as bump hunting in some embodiments) is used to divide the original dataset into smaller data groups/clusters. Each such group contains cases that have similar prediction errors for any of the individual models. Stated differently, cases can be separated according to the prediction power of the individual models. For each data group, therefore, the system can identify the most powerful models, and use them to form an ensemble for the cluster.

In the illustrated embodiment, the workflow 100 begins with an original Dataset 105, which includes both Input Data 110, as well as corresponding Labels 115. The Input Data 110 can generally include any data, such as records or cases including any number of fields. For example, each record/case may correspond to an individual, and include data fields such as name, age, location, and the like. In an embodiment, each Label 115 corresponds to the classification or category of the corresponding record in the Input Data 110. Generally, the ML Models 120A-N are trained to process Input Data 110 (e.g., individual records or cases) and predict the appropriate Label 115.

In one embodiment, the Dataset 105 corresponds to training data used to train the models. In another embodiment, the Dataset 105 is test data and/or validation data. This data includes labeled exemplars, similarly to training data, but is used to verify/evaluate the models rather than to refine them. In the illustrated embodiment, the Input Data 110 is provided to each ML Model 120A-N in the system. That is, the cases, records, or other appropriate data structure making up the Input Data 110 are iteratively provided to each individual ML Model 120A-N. By evaluating each such record, the ML Models 120A-N can generate a corresponding prediction (also referred to as a label, a classification, a category, and the like).

In the illustrated embodiment, for each such record, the system determines the Residue 125A-N, on a per-model basis. For example, the Residue 125A corresponds to the residue of the Input Data 110 with respect to the ML Model 120A. In one embodiment, the Residues 125 are determined based on the generated prediction by the ML Model 120 and the original Labels 115. For example, for a regression model, the Residue 125 for a case (e.g., a segment of the Input Data 110) is the difference between the predicted value (generated by the ML Model 120) and the actual value indicated by the corresponding Label 115. Similarly, for classification problems, the Residue 125 for a case (a segment of the Input Data 110) can be the distance between the vector of the predicted probabilities (generated by the ML Model 120) and the actual classification(s) (indicated by the Label 115).

In the illustrated embodiment, Residues 125A-N are thus generated for each ML Model 120A-N. As illustrated, the original Input Data 110 is then merged with the Residues 125A-N to generate an aggregated/expanded set of data that is then analyzed using a Clustering Model 130. Using the Clustering Model 130, a number of Clusters 130A-N (also referred to as bumps) are generated. In embodiments, any suitable clustering technique (or combination of techniques) may be utilized. These data Clusters 130A-N each represent unique and/or interesting patterns of data, which can be used to build model ensembles and help derive insights.

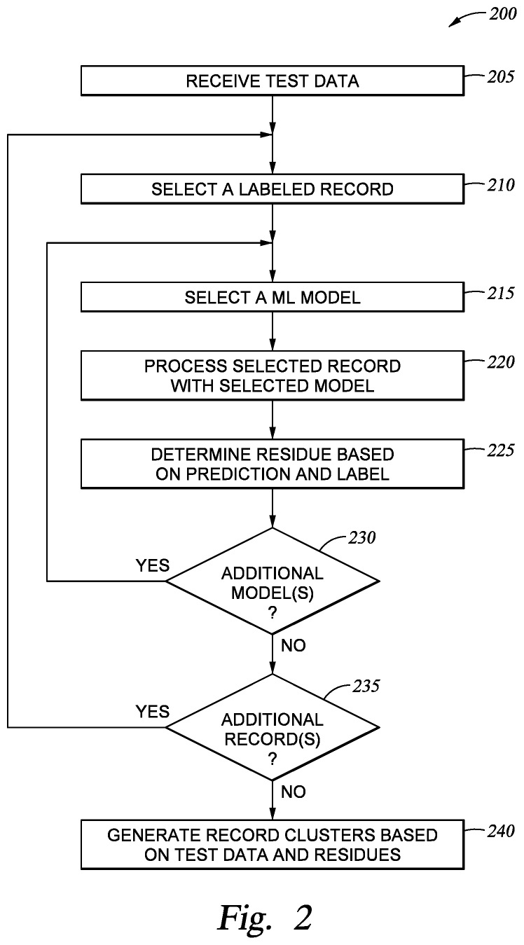

FIG. 2 is a flow diagram illustrating a method 200 for data analysis and clustering to drive improved model ensembles, according to one embodiment disclosed herein. The method 200 begins at block 205, where an ML system receives test data. In one embodiment, the test data includes records, fields, cases, or other data structures/portions of the test data used as input, as well as corresponding labels, classifications, values, or other target output of the ML system. At block 210, the ML system selects a record (or other logical structure) from the test data. The method 200 then continues to block 215, where the ML system selects one of the ML models maintained by the ML system. In an embodiment, the ML system can train and maintain any number and variety of discrete ML models that are trained to receive input data and generate corresponding output predictions (e.g., classifications, values, and the like).

At block 220, the ML system processes the selected record using the selected ML model. As discussed above, this processing includes generating a prediction, using the ML model, based on the input data. The method 200 then proceeds to block 225, where the ML system determines the residue for the selected record based on the generated prediction and the original label (e.g., the difference between them). The method 200 then continues to block 230, where the ML system determines whether there is at least one additional ML model that has not yet been used to process the currently-selected record. If so, the method 200 returns to block 215. Otherwise, the method 200 continues to block 235.

At block 235, the ML system determines whether there is at least one additional record/case in the test data that has not yet been evaluated by the system. If so, the method 200 returns to block 210. Otherwise, the method 200 continues to block 240. At block 240, the ML system generates data clusters by processing the input portion of the test data, along with the determined residues, using one or more clustering techniques. In embodiments, any suitable clustering technique can be utilized. Advantageously, these data clusters represent portions of the data space that include similar records, based not only on the input data but also on the accuracy/residue of each individual model. This enables the ML system to subsequently ensemble models in a more accurate and efficient way.

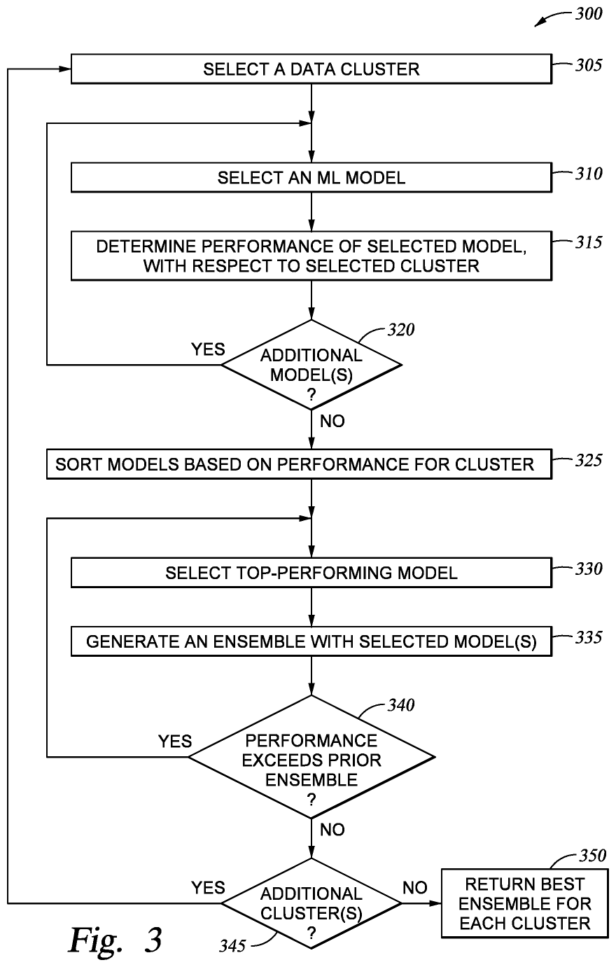

FIG. 3 is a flow diagram illustrating a method 300 for generating model ensembles, according to one embodiment disclosed herein. In embodiments, the differences in prediction accuracies are amplified within each individual data cluster. This allows the ML system to more-readily identify the most powerful/accurate models for any given cluster or case, and to use these models to form an improved ensemble. The method 300 begins at block 305, where a ML system selects one of the identified data clusters. At block 310, the ML system selects one of the trained ML models maintained by the system. The method 300 then proceeds to block 315.

At block 315, the ML system determines the performance of the selected model, with respect to the selected data cluster. In one embodiment, this can include processing one or more records associated with the selected cluster using the selected model, and determining the accuracy of the ML model's predictions (e.g., by comparing each prediction to the true label of the record). In this way, the ML system can determine the cluster-specific accuracy of each ML model for each cluster. The method 300 then continues to block 320, where the ML system determines whether there is at least one additional ML model that has not yet been evaluated with respect to the currently-selected cluster. If so, the method 300 returns to block 310.

If each ML model has been evaluated with respect to the selected cluster, the method 300 continues to block 325. At block 325, the ML system sorts the ML models based on their performance for the selected cluster. For example, the ML system may sort the ML models in descending order, beginning from the highest-accuracy models and proceeding down to the least accurate models for the selected cluster. In one embodiment, this can be conceptualized as generating a stack or queue of models sorted based on their performance. The method 300 then continues to block 330, where the ML system selects the top-performing model in the set. In an embodiment, this includes “popping” or de-queueing the top model from the stack/queue, such that the next “top” model is the next-best performing model.

At block 335, the ML system generates an ML ensemble, which can include one or more models, using the selected top-performing model(s). At block 340, the ML system then evaluates the accuracy of this newly-generated ensemble, and determines whether its performance exceeds the performance of the immediately-prior ensemble. In one embodiment, if this is the first ensemble built by the ML system, the system compares its accuracy to one or more individual ML models, and/or to a user-provided ensemble (e.g., built using existing techniques). If the current ensemble is more accurate than the prior ensemble, the method 300 returns to block 330.

At block 330, the ML system again selects the top-performing ML model, from among the set of ML models that have not yet been selected/used for the selected cluster. That is, suppose the system utilizes three models ranked in descending order from Model A exhibiting the highest accuracy, Model B exhibiting the next-highest, and Model C exhibiting the lowest. In an embodiment, the ML system first selects Model A to build the ensemble. If, at block 340, the ML system determines that this ensemble is better than the prior ensemble (with respect to the selected cluster), the ML system then selects Model B, which is the best-performing model that is not already included in the ensemble. This can then repeat as models are iteratively selected in descending order and added to the current ensemble, until no models remain or until the ML system determines, at block 340, that the new ensemble is worse than the prior ensemble.

Returning to block 340, if the ML system determines that the newly-generated ensemble is less accurate than the immediately-prior ensemble, the ML system stores this immediately-prior ensemble as the best ensemble for the selected cluster, and the method 300 continues to block 345. At block 345, the ML system determines whether at least one additional data cluster has not yet been analyzed to generate a corresponding ensemble. If so, the method 300 returns to block 305. If all data clusters have been processed, however, the method 300 continues to block 350, where the ML system returns the best ensemble(s) for each data cluster. These ensembles can then be used to evaluate newly-received cases.

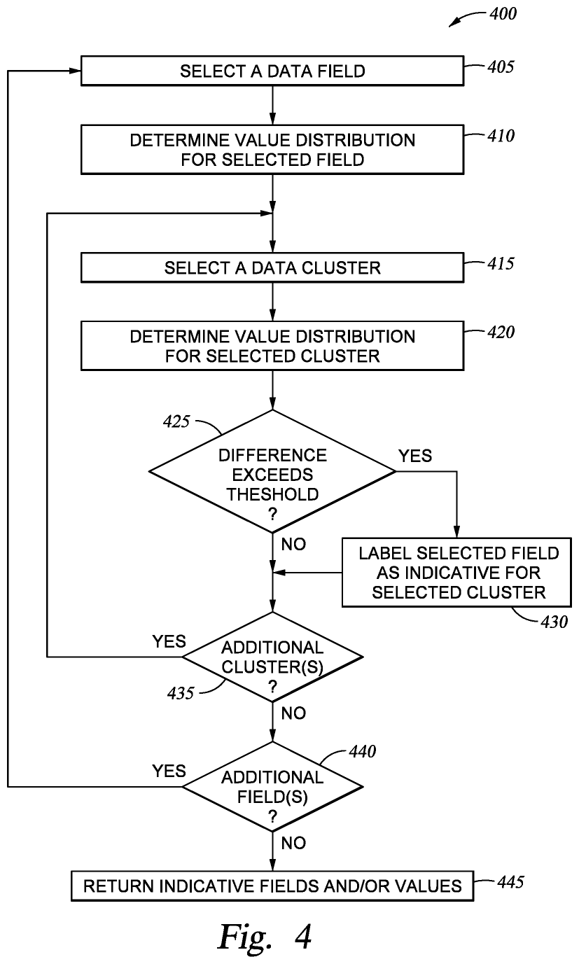

FIG. 4 is a flow diagram illustrating a method for identifying important and/or indicative fields for data classification, according to one embodiment disclosed herein. In one embodiment, the method 400 is utilized after the data clusters have been identified/generated, and is used to identify fields/values in the input data that are indicative of each cluster and/or important to the cluster. That is, because the original predictors are also included in the clustering analysis, the most important predictors can be used to profile the bump/cluster. For example, the ranges, means, and the like of such fields with respect to each cluster. In one embodiment, the importance of a given field refers to how much the distribution of values within the cluster differs from the overall distribution of values for the field. The larger this difference, the more important the field is for the cluster.

The method 400 begins at block 405, where the ML system selects one of the data fields in the input data. At block 410, the ML system determines the distribution of values for the selected field, with respect to the entire original dataset. The method 400 then continues to block 415, where the ML system selects one of the data clusters. At block 420, the ML system determines the distribution of values for the selected field, with respect to the selected data cluster. The method 400 proceeds to block 425.

At block 425, the ML system determines whether the difference between the overall distribution and the cluster-specific distribution exceeds a predefined threshold. If so, the method 400 continues to block 430, where the ML system labels the selected field as indicative/important for the selected cluster. The method 400 then continues to block 435. Returning to block 425, if the ML system determines that the distribution of values in the selected cluster does not differ from the overall distribution by more than the predefined threshold, the method 400 continues to block 435. Although a binary distinction between indicative and non-indicative is illustrated, in some embodiments, each field can instead be scored based on its importance (e.g., from zero to one), where the importance is directly proportional to the magnitude of the difference between the distributions.

At block 435, the ML system determines whether there is at least one additional cluster that has not yet been evaluated for the selected data field. If so, the method 400 returns to block 415 to select the next data cluster. If all such clusters have been evaluated, the method 400 continues to block 440, where the ML system determines whether there is at least one additional field that has not yet been evaluated. If so, the method 400 returns to block 405. Otherwise, the method 400 proceeds to block 445, where the ML system returns indications of which fields are indicative for each cluster, as well as which value(s) of each field are indicative of the cluster. For example, the system may determine that values ranging from 5.0 to 10.0 from an “age” field are indicative of a certain cluster, while vales ranging from 10.0 to 15. 0 are indicative of another.

Additionally, in some embodiments, the ML system simply returns binary indications indicating, for each field/cluster combination, whether the cluster is indicative of or important to the field. Further, in at least one embodiment, the ML system returns the generated importance score of each field, with respect to each individual cluster. These importance scores and/or indications that the field is indicative can thus be used to derive insights about each cluster.

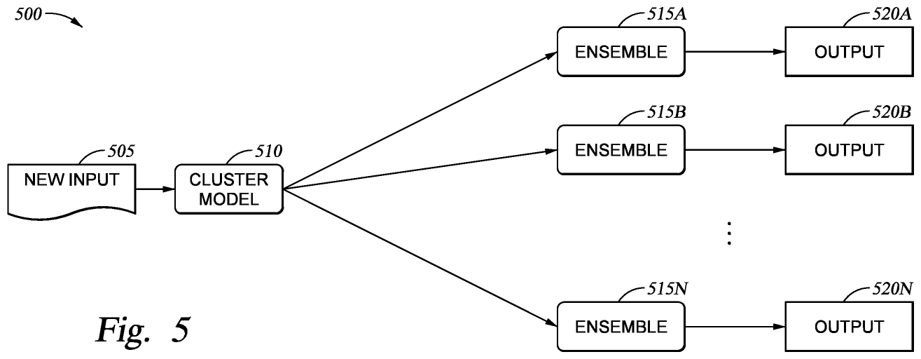

FIG. 5 depicts a workflow 500 for processing input data using model ensembles, according to one embodiment disclosed herein. Given the cluster model (and/or the important/indicative fields) and the generated model ensembles, a new case can be routed to the appropriate model ensemble. In the illustrated workflow 500, a New Input 505 is first evaluated using the Cluster Model 510 (which may correspond to the Cluster Model 130) in order to cluster it into one of the previously-determined data clusters. Note that because the New Input 505 is not yet labeled, model residues are not available for this new case. Thus, in one embodiment, the ML system uses only the predictors (e.g., the input data) in the calculation of distances between the new case and the previously-identified data bumps.

In at least one embodiment, the ML system can alternatively (or additionally) identify the appropriate data cluster by comparing the values of the fields in the New Input 505 to previously-identified indicative fields and/or values for each cluster. If the values of the new input appear to mirror the values of important/indicative fields for a given cluster, the ML system can determine that the new case corresponds to this cluster.

In the depicted workflow 500, the ML system then identifies the Ensemble 515A-N that corresponds to the determined data cluster, and routes the New Input 505 to this Ensemble 515A-N. The corresponding Ensemble 515A-N then generates an Output 520A-N, which may include a prediction, a classification, and the like. In this way, the ML system can dynamically evaluate each new input using the best-performing model ensemble, based on the cluster to which the new input belongs. This yields improved accuracy of the system.

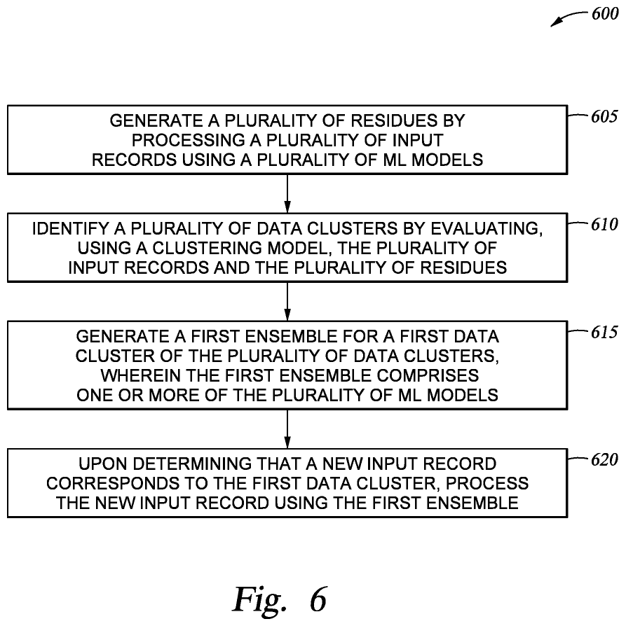

FIG. 6 is a flow diagram illustrating a method 600 to ensemble models, according to one embodiment disclosed herein. The method 600 begins at block 605, where an ML system generates a plurality of residues by processing a plurality of input records using a plurality of machine learning (ML) models. At block 610, the ML system identifies a plurality of data clusters by evaluating, using a clustering model, the plurality of input records and the plurality of residues. The method 600 then proceeds to block 615, where the ML system generates a first ensemble for a first data cluster of the plurality of data clusters, wherein the first ensemble comprises one or more of the plurality of ML models. Further, at block 620, upon determining that a new input record corresponds to the first data cluster, the ML system processes the new input record using the first ensemble.

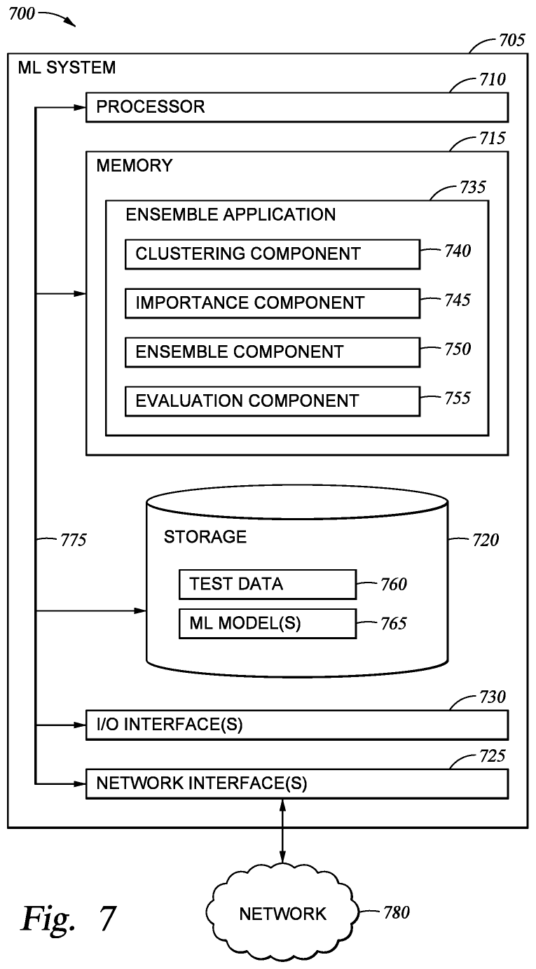

FIG. 7 is a block diagram illustrating an environment 700 including a Machine Learning System 705 configured to perform data-driven analysis to ensemble models, according to one embodiment disclosed herein. Although depicted as a physical device, in embodiments, the ML System 705 may be implemented using virtual device(s), and/or across a number of devices (e.g., in a cloud environment). As illustrated, the ML System 705 includes a Processor 710, Memory 715, Storage 720, a Network Interface 725, and one or more I/O Interfaces 730. In the illustrated embodiment, the Processor 710 retrieves and executes programming instructions stored in Memory 715, as well as stores and retrieves application data residing in Storage 720. The Processor 710 is generally representative of a single CPU and/or GPU, multiple CPUs and/or GPUs, a single CPU and/or GPU having multiple processing cores, and the like. The Memory 715 is generally included to be representative of a random access memory. Storage 720 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, input and output devices (such as keyboards, monitors, etc.) are connected via the I/O Interface(s) 730. Further, via the Network Interface 725, the ML System 705 can be communicatively coupled with one or more other devices and components (e.g., via the Network 780, which may include the Internet, local network(s), and the like). As illustrated, the Processor 710, Memory 715, Storage 720, Network Interface(s) 725, and I/O Interface(s) 730 are communicatively coupled by one or more Buses 775.

In the illustrated embodiment, the Storage 720 includes a set of Test Data 760, as well as one or more ML Models 765. Although depicted as residing in Storage 720, in embodiments, the Test Data 760 and ML Models 765 may be stored in any suitable location. In an embodiment, as discussed above, the Test Data 760 includes a set of inputs with corresponding labels, used to evaluate/validate/test the performance of the ML Models 765. The ML Models 765 can generally include any number and type of model. The ML Models 765 have been trained (e.g., using the Test Data 760, or using other training data) to receive input data and generate corresponding predictions. In one embodiment, the ML Models 765 can include any number of models trained to solve the same problem. For example, the ML Models 765 can include differing architectures, differing parameters or weights, differing hyperparameters, and the like. Nevertheless, in one embodiment, each ML Model 765 is trained to receive the same input data and (attempt to) generate the same output prediction.

In the illustrated embodiment, the Memory 715 includes an Ensemble Application 735. Although depicted as software residing in Memory 715, in embodiments, the functionality of the Ensemble Application 735 can be implemented using hardware, software, or a combination of hardware and software. As illustrated, the Ensemble Application 735 includes a Clustering Component 740, an Importance Component 745, an Ensemble Component 750, and an Evaluation Component 755. Although depicted as discrete components for conceptual clarity, in embodiments, the operations of the Clustering Component 740, Importance Component 745, Ensemble Component 750, and Evaluation Component 755 may be combined or distributed across any number of components and devices.

In an embodiment, the Clustering Component 740 generally uses one or more clustering models and/or techniques to cluster the Test Data 760 into discrete data clusters/bumps, as discussed above. For example, in one embodiment, the Clustering Component 740 utilizes the workflow 100 discussed with reference to FIG. 1, and/or the method 200 discussed with reference to FIG. 2. In some embodiments, the Clustering Component 740 is further used to identify the appropriate cluster for newly-received input data, as discussed above.

In the illustrated embodiment, the Importance Component 745 can be used to iteratively evaluate each cluster in order to identify field(s) and/or values that are important to the cluster and/or indicative of the cluster. For example, in one embodiment, the Importance Component 745 utilizes the method 400, discussed above with reference to FIG. 4. Further, in one embodiment, the Ensemble Component 750 is used to generate and evaluate model ensembles for each cluster, as discussed above. For example, in one embodiment, the Ensemble Component 750 utilizes the method 300 discussed above with reference to FIG. 3. As depicted, the Evaluation Component 755 is generally used to evaluate newly-received cases using one or more ensembles built using the ML Models 765. For example, in one embodiment, the Evaluation Component 755 utilizes the workflow 500 discussed above with reference to FIG. 5.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the preceding and/or following, reference is made to embodiments presented in this disclosure. However, the scope of the present disclosure is not limited to specific described embodiments. Instead, any combination of the preceding and/or following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding and/or following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present disclosure may take the form of an entirely hardware embodiment, an entirely software embodiment (including firmware, resident software, microcode, etc.) or an embodiment combining software and hardware aspects that may all generally be referred to herein as a “circuit,” “module” or “system.”

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present invention, a user may access applications (e.g., the Ensemble Application 735) or related data available in the cloud. For example, the Ensemble Application 735 could execute on a computing system in the cloud and build and utilize dynamic ensembles based on underlying data bumps. In such a case, the Ensemble Application 735 could utilize clustering to identify relevant data bumps for the dataset, and store the clusters and/or generated ensembles for each cluster at a storage location in the cloud. Doing so allows a user to access this information from any computing system attached to a network connected to the cloud (e.g., the Internet).

While the foregoing is directed to embodiments of the present invention, other and further embodiments of the invention may be devised without departing from the basic scope thereof, and the scope thereof is determined by the claims that follow.

What is claimed is:

1. A method, comprising:
generating a plurality of residues by processing a plurality of input records using a plurality of machine learning (ML) models;
identifying a plurality of data clusters by evaluating, using a clustering model, the plurality of input records and the plurality of residues;
generating a first ensemble for a first data cluster of the plurality of data clusters, wherein the first ensemble comprises one or more of the plurality of ML models; and
upon determining that a new input record corresponds to the first data cluster, processing the new input record using the first ensemble.

2. The method of claim 1, wherein generating the plurality of residues comprises generating a set of residues for a first input record of the plurality of input records, comprising:
generating a first prediction by evaluating the first input record using a first ML model of the plurality of ML models;
determining a first residue by comparing the first prediction with a first label for the first input record;
generating a second prediction by evaluating the first input record using a second ML model of the plurality of ML models; and
determining a second residue by comparing the second prediction with the first label.

3. The method of claim 1, wherein generating the first ensemble for the first data cluster comprises:
sorting the plurality of ML models based on their performance with respect to the first data cluster;
selecting a first ML model of the plurality of ML models, based on determining that the first ML model provides a highest performance of the plurality of ML models;
selecting a second ML model of the plurality of ML models, based on determining that the second ML model provides a second-highest performance of the plurality of ML models; and
generating the first ensemble to include the first and second ML models.

4. The method of claim 3, wherein generating the first ensemble for the first data cluster further comprises:
evaluating the first ensemble; and
upon determining that performance of the first ensemble is below a predefined threshold:
selecting a third ML model of the plurality of ML models, based on determining that the third ML model provides a third-highest performance of the plurality of ML models; and
generating the first ensemble to include the first, second, and third ML models.

5. The method of claim 1, the method further comprising:
evaluating the input records belonging to the first data cluster to generate an importance score of one or more data fields with respect to the first data cluster.

6. The method of claim 5, wherein generating the importance score of one or more indicative fields comprises:
determining, for each of a plurality of data fields, a distribution of values in the plurality of input records; and
determining, for a first data field of the plurality of data fields, a distribution of values with respect to the first data cluster; and
generating an importance score for the first data field based on a difference between the distribution of values with respect to the first data cluster and the distribution of values in the plurality of input records.

7. The method of claim 1, wherein determining that the new input record corresponds to the first data cluster comprises:
evaluating the new input record using the clustering model.

8. One or more computer-readable storage media collectively containing computer program code that, when executed by operation of one or more computer processors, performs an operation comprising:
generating a plurality of residues by processing a plurality of input records using a plurality of machine learning (ML) models;
identifying a plurality of data clusters by evaluating, using a clustering model, the plurality of input records and the plurality of residues;
generating a first ensemble for a first data cluster of the plurality of data clusters, wherein the first ensemble comprises one or more of the plurality of ML models; and
upon determining that a new input record corresponds to the first data cluster, processing the new input record using the first ensemble.

9. The computer-readable storage media of claim 8, wherein generating the plurality of residues comprises generating a set of residues for a first input record of the plurality of input records, comprising:
generating a first prediction by evaluating the first input record using a first ML model of the plurality of ML models;
determining a first residue by comparing the first prediction with a first label for the first input record;
generating a second prediction by evaluating the first input record using a second ML model of the plurality of ML models; and
determining a second residue by comparing the second prediction with the first label.

10. The computer-readable storage media of claim 8, wherein generating the first ensemble for the first data cluster comprises:
sorting the plurality of ML models based on their performance with respect to the first data cluster;
selecting a first ML model of the plurality of ML models, based on determining that the first ML model provides a highest performance of the plurality of ML models;
selecting a second ML model of the plurality of ML models, based on determining that the second ML model provides a second-highest performance of the plurality of ML models; and
generating the first ensemble to include the first and second ML models.

11. The computer-readable storage media of claim 10, wherein generating the first ensemble for the first data cluster further comprises:
evaluating the first ensemble; and
upon determining that performance of the first ensemble is below a predefined threshold:
selecting a third ML model of the plurality of ML models, based on determining that the third ML model provides a third-highest performance of the plurality of ML models; and
generating the first ensemble to include the first, second, and third ML models.

12. The computer-readable storage media of claim 8, the operation further comprising:
evaluating the input records belonging to the first data cluster to generate an importance score of one or more data fields with respect to the first data cluster.

13. The computer-readable storage media of claim 12, wherein generating the importance score of one or more indicative fields comprises:
determining, for each of a plurality of data fields, a distribution of values in the plurality of input records; and
determining, for a first data field of the plurality of data fields, a distribution of values with respect to the first data cluster; and
generating an importance score for the first data field based on a difference between the distribution of values with respect to the first data cluster and the distribution of values in the plurality of input records.

14. The computer-readable storage media of claim 8, wherein determining that the new input record corresponds to the first data cluster comprises:
evaluating the new input record using the clustering model.

15. A system comprising:
one or more computer processors; and
one or more memories collectively containing one or more programs which when executed by the one or more computer processors performs an operation, the operation comprising:
generating a plurality of residues by processing a plurality of input records using a plurality of machine learning (ML) models;
identifying a plurality of data clusters by evaluating, using a clustering model, the plurality of input records and the plurality of residues;
generating a first ensemble for a first data cluster of the plurality of data clusters, wherein the first ensemble comprises one or more of the plurality of ML models; and
upon determining that a new input record corresponds to the first data cluster, processing the new input record using the first ensemble.

16. The system of claim 15, wherein generating the plurality of residues comprises generating a set of residues for a first input record of the plurality of input records, comprising:
generating a first prediction by evaluating the first input record using a first ML model of the plurality of ML models;
determining a first residue by comparing the first prediction with a first label for the first input record;
generating a second prediction by evaluating the first input record using a second ML model of the plurality of ML models; and
determining a second residue by comparing the second prediction with the first label.

17. The system of claim 15, wherein generating the first ensemble for the first data cluster comprises:
sorting the plurality of ML models based on their performance with respect to the first data cluster;
selecting a first ML model of the plurality of ML models, based on determining that the first ML model provides a highest performance of the plurality of ML models;
selecting a second ML model of the plurality of ML models, based on determining that the second ML model provides a second-highest performance of the plurality of ML models; and
generating the first ensemble to include the first and second ML models.

18. The system of claim 17, wherein generating the first ensemble for the first data cluster further comprises:
evaluating the first ensemble; and
upon determining that performance of the first ensemble is below a predefined threshold:
selecting a third ML model of the plurality of ML models, based on determining that the third ML model provides a third-highest performance of the plurality of ML models; and
generating the first ensemble to include the first, second, and third ML models.

19. The system of claim 15, the operation further comprising:
evaluating the input records belonging to the first data cluster to generate an importance score of one or more data fields with respect to the first data cluster, wherein generating the importance score of one or more indicative fields comprises:
determining, for each of a plurality of data fields, a distribution of values in the plurality of input records; and
determining, for a first data field of the plurality of data fields, a distribution of values with respect to the first data cluster; and
generating an importance score for the first data field based on a difference between the distribution of values with respect to the first data cluster and the distribution of values in the plurality of input records.

20. The system of claim 15, wherein determining that the new input record corresponds to the first data cluster comprises:
evaluating the new input record using the clustering model.
